(19) United States
(12) Patent Application Publication
(10) Pub. No.: US 2017/0361306 A1
(43) Pub. Date: Dec. 21, 2017

(54) DIATOMACEOUS EARTH PRODUCTS, PROCESSES FOR PREPARING THEM, AND METHODS OF THEIR USE

(71) Applicant: IMERYS FILTRATION MINERALS, INC., San Jose, CA (US)

(72) Inventor: BO WANG, Union City, CA (US)

(21) Appl. No.: 15/695,895

(22) Filed: Sep. 5, 2017

Related U.S. Application Data
(63) Continuation of application No. 14/367,104, filed on Jun. 19, 2014.
(60) Provisional application No. 61/578,326, filed on Dec. 21, 2011.

(51) Int. Cl. B01J 20/30; B01J 20/28; B01D 39/20; B01J 20/26; B01J 20/14; C12H 1/07; B01D 37/02

(52) U.S. Cl. CPC B01J 20/3078; C12H 1/063; B01J 20/3042; B01J 20/3028; B01J 20/2803; B01D 37/025; B01J 20/262; B01J 20/14; B01J 20/28004; B01D 39/2079; B01D 2239/086

(57) ABSTRACT

A particulate material includes agglomerated diatomaceous earth and a silicone binder. A process for preparing a diatomaceous earth product includes agglomerating at least one natural diatomaceous earth with at least one silicone material, and subjecting the agglomerated diatomaceous earth to at least one heat treatment at a temperature ranging from about 600° C. to about 1,000° C. A filter aid composition includes a diatomaceous earth product including an agglomerated diatomaceous earth and a silicone material. A method of filtering at least one liquid includes passing the at least one liquid through at least one filter membrane including a diatomaceous earth product including agglomerated diatomaceous earth and a silicone material.

CLAIM FOR PRIORITY

This PCT International Application claims the benefit of priority of U.S. Provisional Patent Application No. 61/578,326, filed Dec. 21, 2011, the subject matter of which is incorporated herein by reference in its entirety.

### DESCRIPTION

Disclosed herein are diatomaceous earth products, processes for preparing diatomaceous earth products, and methods for using diatomaceous earth products.

### BACKGROUND

Diatomaceous earth products are obtained from diatomaceous earth (also called “DE” or “diatomite”), which is generally known as a sediment enriched in biogenic silica (i.e., silica produced or brought about by living organisms) in the form of siliceous skeletons (frustules) of diatoms. Diatoms are a diverse array of microscopic, single-celled, golden-brown algae generally of the class Bacillariophyceae that possess an ornate siliceous skeleton of varied and intricate structures comprising two valves that, in the living diatom, fit together much like a pill box.

Diatomaceous earth may be formed from the remains of water-borne diatoms and, therefore, diatomaceous earth deposits may be found close to either current or former bodies of water. Those deposits are generally divided into two categories based on source: freshwater and saltwater. Freshwater diatomaceous earth is generally mined from dry lakebeds and may be characterized as having a low crystalline silica content and a high iron content. In contrast, saltwater diatomaceous earth is generally extracted from oceanic areas and may be characterized as having a high crystalline silica content and a low iron content.

In the field of filtration, methods of particle separation from fluids may employ diatomaceous earth products as filter aids. The intricate and porous structure unique to diatomaceous earth may, in some instances, be effective for the physical entrapment of particles in filtration processes. It is known to employ diatomaceous earth products to improve the clarity of fluids that exhibit turbidity or contain suspended particles or particulate matter.

Diatomaceous earth may be used in various aspects of filtration. For example, as a part of pre-coating, diatomaceous earth products may be applied to a filter septum to assist in achieving, for example, any one or more of protection of the septum, improvement in clarity, and expediting of filter cake removal. As a part of body feeding, diatomaceous earth may be added directly to a fluid being filtered to assist in achieving, for example, either or both of increases flow rate and extensions of the filtration cycle. Depending on the desired attributes of the specific separation process, diatomaceous earth may be used in multiple stages including, but not limited to, in pre-coating and in body feeding.

Prior art diatomaceous earth products may suffer from any number of possible drawbacks that render them less desirable, or cause them to have poor or improvable performance in a particular application, for example, in filtering applications. For example, prior art diatomaceous earth products may have at least one of high crystalline silica content, high impurity content, and low permeability. There may exist a desire to provide improved diatomaceous earth products that exhibit better performance in a given application, such as lower crystalline silica content and/or higher permeability and lower turbdity in filtration applications.

### SUMMARY

According to a first aspect, a particulate composition may include an agglomerated diatomaceous earth and a silicone binder. The product may have a d₁₀ ranging from about 8 μm to about 13 μm, a d₅₀ ranging from about 20 μm to about 35 μm, and/or a d₉₀ ranging from about 60 μm to about 90 μm. The product may have a permeability ranging from about 0.16 darcy to about 2.5 darcies, for example, from about 0.20 darcy to about 0.50 darcy. The product may include a crystalline silica level less than about 1% by weight. In another aspect, the diatomaceous earth product may have a quartz content less than about 1% by weight. In a further aspect, the diatomaceous earth product may have a cristobalite content less than about 1% by weight.

According to a further aspect, the silicone material may include a silicone solution, and the silicone solution may include from about 1% to about 15% by weight, relative to the weight of the DE . For example, the silicone solution may include from about 1% to about 5% by weight, relative to the weight of the DE.

According another aspect, the product may have a beer soluble iron content of less than about 40 ppm, as measured by ASBC.

According to a further aspect, the silicone material may include a silicone polymer including at least one of linear polymers, ring-shaped polymers, branched polymers, cross-linked polymers, and resins.

According to yet another aspect, the product may have a pore diameter ranging from about 3.5 μm to about 5.0 μm. For example, the product may have a pore diameter ranging from about 3.7 μm to about 4.4 μm. According to a further aspect, the product may have a pore volume ranging from about 3.5 mL/g to about 5.0 mL/g. For example, the product may have a pore volume ranging from about 3.9 mL/g to about 4.7 mL/g.

According to a further aspect, the product may have a wet density ranging from about 10 lb/ft³ to about 25 lb/ft³. According to another aspect, the product may have a BET surface area ranging from about 15 m²/g to about 50 m²/g.

According to yet another aspect, a process for preparing a diatomaceous earth product may include agglomerating at least one natural diatomaceous earth with at least one silicone material, and subjecting the agglomerated diatomaceous earth to at least one heat treatment at a temperature ranging from about 600° C. to about 1,000° C. According to another aspect, the process may include subjecting the at least one natural diatomaceous earth to at least one classification step prior to agglomerating. According to another aspect, the process may include subjecting the agglomerated diatomaceous earth to at least one classification step prior to the at least one heat treatment. According to a further aspect, the process may include subjecting the heat treated diatomaceous earth to at least one classification step.

According to still another aspect, the agglomerating may include preparing at least one aqueous solution including the at least one silicone material, and contacting the at least one natural diatomaceous earth with the at least one aqueous solution. For example, the contacting may be by mixing. According to another aspect, the aqueous solution may be about 1% to about 10% by weight of the at least one silicone material, relative to the weight of the DE. For example, the aqueous solution may be about 1% to about 5% by weight at least one silicone material, relative to the weight of the DE. According to a further aspect, the at least one aqueous solution may include less than about 20% by weight water, relative to the weight of the DE. For example, the aqueous solution may include less than or equal to about 10% by weight water, relative to the weight of the DE. According to another aspect, the contacting includes spraying the at least one aqueous solution onto the at least one natural diatomaceous earth.

According to yet another aspect, about 0.25 parts to about 1.5 parts of the at least one aqueous solution may be contacted with about 1 part of the at least one natural diatomaceous earth. For example, about 1 part of the at least one aqueous solution may be contacted with about 1 part of the at least one natural diatomaceous earth.

According to still a further aspect, a filter aid composition may include a diatomaceous earth product including an agglomerated diatomaceous earth and a silicone material. According to another aspect, the filter aid may include at least one additional filter aid.

According to yet another aspect, a method of filtering at least one liquid may include passing the at least one liquid through at least one filter membrane including a diatomaceous earth product that includes agglomerated diatomaceous earth and a silicone material. For example, the at least one liquid may be chosen from a beverage, an edible oil, and a fuel oil. For example, the beverage may be wine.

### BRIEF DESCRIPTION OF THE DRAWINGS

FIG. 1A is a graph depicting pressure versus filtration time for the diatomaceous earth filter aid discussed in Example 3.

FIG. 1B is a graph depicting turbidity versus filtration time for the diatomaceous earth filter aid discussed in Example 3.

FIG. 2A is a graph depicting pressure versus filtration time for the diatomaceous earth filter aid discussed in Example 5.

FIG. 2B is a graph depicting turbidity versus filtration time for the diatomaceous earth filter aid discussed in Example 5.

FIG. 3A is a graph depicting pressure versus filtration time for the diatomaceous earth filter aid discussed in Example 16.

FIG. 3B is a graph depicting turbidity versus filtration time for the diatomaceous earth filter aid discussed in Example 16.

### DESCRIPTION OF EXEMPLARY EMBODIMENTS

Disclosed herein are diatomaceous earth products, processes for preparing diatomaceous earth products, and methods for using the diatomaceous earth products as, for example, filter aids. In some embodiments, the diatomaceous earth product has improved permeability compared to at least one natural diatomaceous earth from which it is made. In other embodiments, the diatomaceous earth product has improved permeability compared to at least one natural diatomaceous earth subjected only to at least one heat treatment, without agglomeration with at least one silicone material. In some embodiments, the diatomaceous earth product has a permeability comparable to that of diatomaceous earth products prepared without agglomeration by heat treatment (e.g., calcination or flux calcination) at a relatively higher temperature. In further embodiments, the diatomaceous earth product has a reduced crystalline silica content compared to diatomaceous earth products prepared without agglomeration by heat treatment (e.g., calcination or flux calcination) at a relatively higher temperature. In still other embodiments, the diatomaceous earth product has improved permeability compared to calcined or flux-calcined diatomaceous earth products. In other embodiments, the diatomaceous earth product has reduced crystalline silica content and increase permeability compared to calcined or flux-calcined diatomaceous earth products.

In some embodiments, the diatomaceous earth product, when included in a filter aid composition, enhances filter aid performance compared to the filter aid composition itself. In other embodiments, the diatomaceous earth product, when included in a filter aid product, enhances filter aid performance compared to commercially available filter aids. In further embodiments, the process disclosed herein achieves energy savings by reducing the calcination temperatures compared to the temperatures used in traditional and fluxed calcinations.

### Exemplary Natural Diatomaceous Earth

Some exemplary processes for preparing the exemplary diatomaceous earth products of the present disclosure include at least one natural diatomaceous earth as a starting material. As used herein, the term “natural diatomaceous earth” means any diatomaceous earth material that has not been subjected to thermal treatment (e.g., calcination) sufficient to induce formation of greater than 1% cristobalite. In some embodiments, the at least one natural diatomaceous earth is obtained from a saltwater source. In other embodiments, the at least one natural diatomaceous earth is obtained from a freshwater source. In further embodiments, the at least one natural diatomaceous earth is any diatomaceous earth material that may be capable of use in a filter aid product, either in its crude form or after subjecting the material to one or more processing steps. In still other embodiments, the at least one natural diatomaceous earth is any diatomaceous earth material that has not been subjected to at least one thermal treatment. In further embodiments, the at least one natural diatomaceous earth is any diatomaceous earth material that has not been subjected to calcination.

As stated earlier, natural diatomaceous earth is, in general, a sedimentary biogenic silica deposit comprising the fossilized skeletons of diatoms, one-celled algae-like plants that accumulate in marine or fresh water environments. Honeycomb silica structures generally give diatomaceous earth useful characteristics, such as, for example, absorptive capacity and surface area, chemical stability, and low-bulk density. In some embodiments, natural diatomaceous earth includes about 90% SiO₂ mixed with other substances. In other embodiments, crude diatomaceous earth includes about 90% SiO₂ and various metal oxides, such as, but not limited to, Al, Fe, Ca, and Mg oxides.

The at least one natural diatomaceous earth may have any of various appropriate forms now known to the skilled artisan or hereafter discovered. In some embodiments, the at least one natural diatomaceous earth is unprocessed (e.g., not subjected to chemical and/or physical modification processes). Without wishing to be bound by theory, the impurities in natural diatomaceous earth, such as, for example, clays and organic matters, may, in some embodiments, provide higher cation exchange capacity. In other embodiments, the at least one natural diatomaceous earth undergoes minimal processing following mining or extraction. In further embodiments, the at least one natural diatomaceous earth is subjected to at least one physical modification process. Appropriate physical modification processes may include, but are not limited to, milling, drying, and air classifying. In some embodiments, the at least one natural diatomaceous earth is subjected to at least one chemical modification process. Appropriate chemical modification processes may include, but are not limited to, silanization. Silanization may be used to render the surfaces of the at least one natural diatomaceous earth either more hydrophobic or hydrophilic using the methods appropriate for silicate minerals. See U.S. Pat. No. 3,915,735 and U.S. Pat. No. 4,260,498, the contents of which are incorporated herein by reference in their entireties.

In some embodiments useful for increasing hydrophobicity, the at least one natural diatomaceous earth is placed in a plastic vessel, and a small quantity of dimethyldichlorosilane (SiCl₂(CH₃)₂) or hexadimethylsilazane ((CH₃)₃Si—NH—Si(CH₃)₃) is added to the vessel. The reaction is allowed to take place at the at least one natural diatomaceous earth surface in the vapor phase over a 24-hour period. In some embodiments, hydrophobically enhanced diatomaceous earth may have application in chromatographic compositions. In other embodiments, hydrophobically enhanced diatomaceous earth, for example, when used in conjunction with at least one additional hydrophobic material, may provide improved mechanical performance in applications involving hydrocarbons and/or oils. In further embodiments, hydrophobically enhanced diatomaceous earth, for example, when used in conjunction with at least one additional hydrophobic material, may provide reinforcement in applications involving plastics and/or other polymers.

In some embodiments, the at least one natural diatomaceous earth is a commercially available diatomaceous earth product. For example, the at least one natural diatomaceous earth is Celite® S available from World Minerals, Inc.

### Exemplary Silicone Material

The at least one natural diatomaceous earth material is subjected to at least one agglomeration with at least one silicone material (e.g., a silicone binder). For example, the at least one silicone material may include one or more of silicone polymers, such as, for example, linear silicone polymers, ring-shaped silicone polymers, branched silicone polymers, cross-linked silicone polymers, and resin silicone polymers. In some embodiments, the at least one natural diatomaceous earth material is agglomerated with at least one silicone polymer material.

### Exemplary Agglomeration

Agglomeration of at least one natural diatomaceous earth material and at least one silicone, or of at least one heat-treated diatomaceous earth and at least one silicone material, may occur through any appropriate agglomeration process. In some embodiments, agglomeration comprises preparing at least one aqueous silicone solution of the at least one silicone material, and contacting the at least one aqueous silicone solution with the at least one diatomaceous earth. One or more agglomerations may be performed, for example, when multiple silicone materials, multiple diatomaceous earths, and/or multiple silicone solutions are used.

In some embodiments, contacting includes mixing a silicone solution with at least one diatomaceous earth. In some embodiments, the mixing includes agitation. In some embodiments, at least one diatomaceous earth material and a silicone solution are mixed sufficiently to at least substantially uniformly distribute the silicone solution among the agglomeration points of contact of the at least one diatomaceous earth. In some embodiments, the at least one diatomaceous earth and the silicone solution are mixed with sufficient agitation to at least substantially uniformly distribute the silicone solution among the agglomeration points of contact of the at least one diatomaceous earth without damaging the structure of the diatomaceous earth. In some embodiments, contacting includes low-shear mixing.

In some embodiments, mixing occurs for about 1 hour. In other embodiments, mixing occurs for less than about 1 hour. In some embodiments, mixing occurs for about 30 minutes. In some embodiments, mixing occurs for about 20 minutes. In some embodiments, mixing occurs for about 10 minutes.

In some embodiments, mixing occurs at about room temperature (i.e., from about 20° C. to about 23° C.). In some embodiments, mixing occurs at a temperature of from about 20° C. to about 50° C. In some embodiments, mixing occurs at a temperature of from about 30° C. to about 45° C. In some embodiments, mixing occurs at a temperature of from about 35° C. to about 40° C.

In some embodiments, contacting includes spraying at least one diatomaceous earth with at least one silicone solution. In some embodiments, the spraying is intermittent. In some embodiments, the spraying is continuous. In some embodiments, spraying includes mixing the at least one diatomaceous earth while spraying with the at least one silicone solution, for example, to expose different agglomeration points of contacts to the spray. In other embodiments, such mixing is intermittent. In further embodiments, such mixing is continuous.

In some embodiments, the at least one silicone material is present in the at least one silicone solution in an amount from less than about 40% by weight, relative to the weight of the at least one silicone solution. In other embodiments, the at least one silicone material ranges from about 1% to about 15% by weight, relative to the weight of the DE. In further embodiments, the at least one silicone material ranges from about 1% to about 5% by weight, relative to the weight of the DE.

The at least one aqueous solution of the at least one silicone material may be prepared with water. In some embodiments, the water is deionized water. In other embodiments, the water is ultrapure water. In further embodiments, the water has been treated to remove or decrease the levels of metals, toxins, and/or other undesirable elements before it is contacted with the at least one silicone material. According to some embodiments, the silicone solution may include less than about 20% by weight water. For example, the silicone solution may include less than about 15% by weight water, such as, for example, less than or equal to about 10% by weight water. According to some embodiments, the silicone solution may include less than or equal to about 5% by weight water. According to some embodiments, the relatively low water content in the silicone solution may be beneficial in reducing the amount of drying of the mixture of diatomaceous earth and silicone material, for example, prior to heat treatment. For example, it may reduce or substantially eliminate drying prior to calcination.

The amount of at least one aqueous solution contacted with the at least one diatomaceous earth may range from about 0.25 parts to about 1.5 parts of aqueous solution to 1 part diatomaceous earth. In some embodiments, about 1 part aqueous solution is contacted with about 1 part diatomaceous earth.

### Exemplary Classification

Before and/or after the at least one agglomeration, the diatomaceous earth may, in some embodiments, be subjected to at least one classification step. Before and/or after the at least one heat treatment, the diatomaceous earth may, in some embodiments, be subjected to at least one classification step. In some embodiments, the particle size of the diatomaceous earth material is adjusted to a suitable or desired size using any one of several techniques well known in the art. In other embodiments, the diatomaceous earth material is subjected to at least one mechanical separation to adjust the powder size distribution. Appropriate mechanical separation techniques are well known to the skilled artisan and include, but are not limited to, milling, grinding, screening, extrusion, triboelectric separation, liquid classification, aging, and air classification.

### Exemplary Heat Treatment

According to some embodiments, the natural diatomaceous earth or agglomerated diatomaceous earth is subjected to at least one heat treatment. Appropriate heat treatment processes are well-known to the skilled artisan, and include those now known or that may hereinafter be discovered. In some embodiments, the least one heat treatment decreases the amount of organics and/or volatiles in the heat-treated diatomaceous earth. In other embodiments, the at least one heat treatment includes at least one calcination. In further embodiments, the at least one heat treatment includes at least one flux calcination. In yet other embodiments, the at least one heat treatment includes at least one roasting.

Calcination may be conducted according to any appropriate process now known to the skilled artisan or hereafter discovered. In some embodiments, calcination is conducted at temperatures below the melting point of the at least one diatomaceous earth. In other embodiments, calcination is conducted at a temperature ranging from about 600° C. to about 1,000° C. In further embodiments, the calcination temperature ranges from about 600° C. to about 700° C. In yet other embodiments, the calcination temperature ranges from about 700° C. to about 800° C. In still further embodiments, the calcination temperature ranges from about 800° C. to about 900° C. In further embodiments, the calcination temperature ranges from about 900° C. to about 1,000° C. In still other embodiments, the calcination temperature is chosen from the group consisting of about 600° C., about 700° C., about 800° C., about 900° C., and about 1,000° C. Heat treatment at a lower temperature may result in an energy savings over other processes for the preparation of diatomaceous earth products.

Flux calcination includes conducting at least one calcination in the presence of at least one fluxing agent. Flux calcination may be conducted according to any appropriate process now known to the skilled artisan or hereafter discovered. In some embodiments, the at least one fluxing agent is any material now known to the skilled artisan or hereafter discovered that may act as a fluxing agent. In other embodiments, the at least one fluxing agent is a salt including at least one alkali metal. In further embodiments, the at least one fluxing agent is chosen from the group consisting of carbonate, silicate, chloride, and hydroxide salts. In yet other embodiments, the at least one fluxing agent is chosen from the group consisting of sodium, potassium, rubidium, and cesium salts. In yet further embodiments, the at least one fluxing agent is chosen from the group consisting of sodium, potassium, rubidium, and cesium carbonate salts.

Roasting may be conducted according to any appropriate process now known to the skilled artisan or hereafter discovered. In some embodiments, roasting is a calcination process conducted at a generally lower temperature that helps to avoid formation of crystalline silica in the diatomaceous earth. In some embodiments, roasting is conducted at a temperature ranging from about 450° C. to about 1,000° C. In further embodiments, the roasting temperature ranges from about 500° C. to about 800° C. In yet other embodiments, the roasting temperature ranges from about 600° C. to about 700° C. In still further embodiments, the roasting temperature ranges from about 700° C. to about 1,000° C. In other embodiments, the roasting temperature is chosen from the group consisting of about 450° C., about 500° C., about 600° C., about 700° C., about 800° C., about 900° C., and about 1,000° C.

In one embodiment, when calcined, roasted or theat treated, the silicone binder decomposes, but leaves behind a silica backbone binding the agglomerated DE particles. This silica backbone can provide a relatively high mechanical strength bond in comparison to that provided by organic binders.

It is within the scope of the present disclosure to subject the at least one diatomaceous earth to at least one heat treatment, followed by agglomerating the heat treated diatomaceous earth with at least one silicone material.

### Exemplary Diatomaceous Earth Products

The diatomaceous earth products made by the exemplary processes described herein may have one or more beneficial attributes, rendering them potentially desirable for use in one or a number of given applications. In some embodiments, the diatomaceous earth product is useful as part of a filter aid composition. In other embodiments, a filter aid composition includes at least one embodiment of diatomaceous earth product.

The diatomaceous earth products disclosed herein may have a permeability suitable for use in a filter aid composition. Permeability may be measured by any appropriate measurement technique now known to the skilled artisan or hereafter discovered. Permeability is generally measured in darcy units or darcy, as determined by the permeability of a porous bed 1 cm high and with a 1 cm² section through which flows a fluid with a viscosity of 1 mPa·s with a flow rate of 1 cm³/sec under an applied pressure differential of 1 atmosphere. The principles for measuring permeability have been previously derived for porous media from Darcy's law (see, for example, J. Bear, “The Equation of Motion of a Homogeneous Fluid: Derivations of Darcy's Law,” in Dynamics of Fluids in Porous Media 161-177 (2nd ed. 1988)). An array of devices and methods exist that may correlate with permeability. In some exemplary methods useful for measuring permeability, a specially-constructed device is designed to form a filter cake on a septum from a suspension of filtration media in water; the time required for a specified volume of water to flow through a measured thickness of filter cake of known cross-sectional area is measured.

In some embodiments, the diatomaceous earth product has a permeability ranging from about 0.2 darcy to about 3.0 darcies. In some embodiments, the diatomaceous earth product has a permeability ranging from about 0.4 darcy to about 2.5 darcies. In further embodiments, the diatomaceous earth product has a permeability ranging from about 0.2 darcy to about 0.4 darcy. In yet other embodiments, permeability ranges from about 0.5 darcy to about 1 darcy. In yet further embodiments, the permeability ranges from about 1 darcy to about 2 darcies.

Diatomaceous earth products disclosed herein may have a specific particle size. Particle size may be measured by any appropriate measurement technique now known to the skilled artisan or hereafter discovered. In some embodiments, particle size and particle size properties, such as particle size distribution (“psd”), are measured using a Leeds and Northrup Microtrac X100 laser particle size analyzer (Leeds and Northrup, North Wales, Pa., USA), which can determine particle size distribution over a particle size range from 0.12 μm to 704 μm. The size of a given particle is expressed in terms of the diameter of a sphere of equivalent diameter that sediments through the suspension, also known as an equivalent spherical diameter or “esd.” The median particle size, or d₅₀ value, is the value at which 50% by weight of the particles have an esd less than that d₅₀ value. The d₁₀ value is the value at which 10% by weight of the particles have an esd less than that d₁₀ value. The d₉₀ value is the value at which 90% by weight of the particles have an esd less than that d₉₀ value.

In some embodiments, the d₁₀ of the diatomaceous earth product ranges from about 9 μm to about 15 μm, for example, from about 8 μm to about 13 μm. In other embodiments, the d₁₀ is less than about 20 μm. In further embodiments, the d₁₀ is about 9 μm. In yet other embodiments, the d₁₀ is about 10 μm. In still further embodiments, the d₁₀ is about 11 μm. In still other embodiments, the d₁₀ is about 12 μm. In still further embodiments, the d₁₀ is about 13 μm. In other embodiments, the d₁₀ is about 14 μm.

In some embodiments, the d₅₀ of the diatomaceous earth product ranges from about 20 μm to about 45 μm, for example, from about 20 μm to about 35 μm. In other embodiments, the d₅₀ ranges from about 25 μm to about 40 μm. In further embodiments, the d₅₀ ranges from about 30 μm to about 35 μm.

In some embodiments, the d₉₀ of the diatomaceous earth product ranges from about 55 μm to about 120 μm, for example, from about 60 μm to about 90 μm. In other embodiments, the d₉₀ ranges from about 70 μm to about 90 μm. In further embodiments, the d₉₀ ranges from about 75 μm to about 85 μm. In still other embodiments, the d₉₀ ranges from about 80 μm to about 90 μm.

Diatomaceous earth products disclosed herein may have a low crystalline silica content. Forms of crystalline silica include, but are not limited to, quartz, cristobalite, and tridymite. In some embodiments, a diatomaceous earth product has a lower content of at least one crystalline silica than a calcined diatomaceous earth product not subjected to at least one agglomeration with at least one silicone material.

Diatomaceous earth products disclosed herein may have a low cristobalite content. Cristobalite content may be measured by any appropriate measurement technique now known to the skilled artisan or hereafter discovered. In some embodiments, cristobalite content is measured by x-ray diffraction. Cristobalite content may be measured, for example, by the quantitative X-ray diffraction method outlined in H. P. Klug and L. E. Alexander, X-Ray Diffraction Procedures for Polycrystalline and Amorphous Materials 531-563 (2nd ed. 1972), which is incorporated by reference herein in its entirety. According to some embodiments of that method, a sample is milled in a mortar and pestle to a fine powder, then back-loaded into a sample holder. The sample and its holder are placed into the beam path of an X-ray diffraction system and exposed to collimated X-rays using an accelerating voltage of 40 kV and a current of 20 mA focused on a copper target. Diffraction data are acquired by step-scanning over the angular region representing the interplanar spacing within the crystalline lattice structure of cristobalite, yielding the greatest diffracted intensity. That region ranges from 21 to 23 2θ (2-theta), with data collected in 0.05 2θ steps, counted for 20 seconds per step. The net integrated peak intensity is compared with those of standards of cristobalite prepared by the standard additions method in amorphous silica to determine the weight percent of the cristobalite phase in a sample.

In some embodiments, the cristobalite content is less than about 1% by weight. In other embodiments, the cristobalite content is less than about 0.5% by weight. In further embodiments, the cristobalite content is less than about 0.25% by weight. In still other embodiments, the cristobalite content is less than about 0.15% by weight. In further embodiments, the cristobalite content ranges from about 0.05% to about 1% In still other embodiments, the cristobalite content ranges from about 0.10% to about 0.25%. In further embodiments, a diatomaceous earth product has a lower cristobalite content than a heat-treated diatomaceous earth product not subjected to at least one agglomeration with at least one silicone material.

Diatomaceous earth products disclosed herein may have a low quartz content. Quartz content may be measured by any appropriate measurement technique now known to the skilled artisan or hereafter discovered. In some embodiments, quartz content is measured by x-ray diffraction. For example, quartz content may be measured by the same x-ray diffraction method described above for cristobalite content, except the that 2θ region ranges from 26.0 to 27.5 degrees. In some embodiments, the quartz content is less than about 0.5% by weight. In other embodiments, the quartz content is less than about 0.25% by weight. In further embodiments, the quartz content is less than about 0.1% by weight. In still other embodiments, the quartz content is about 0% by weight. In further embodiments, the quartz content ranges from about 0% to about 0.5% by weight. In other embodiments, the quartz content ranges from about 0% to about 0.25% by weight.

Diatomaceous earth products disclosed herein may have a measurable pore volume. Pore volume may be measured by any appropriate measurement technique now known to the skilled artisan or hereafter discovered. In some embodiments, pore volume is measured with an AutoPore IV 9500 series mercury porosimeter from Micromeritics Instrument Corporation (Norcross, Ga., USA), which can determine pore diameters ranging from 0.006 to 600 μm. As used to measure the pore volume of the diatomaceous earth products disclosed herein, that porosimeter's contact angle was set at 130 degree, and the pressure ranged from 0 to 33,000 psi. In some embodiments, the pore volume is about equal to at least one natural diatomaceous earth from which it is made. In other embodiments, the pore volume ranges from about 3.5 mL/g to about 5.0 mL/g. In other embodiments, the pore volume ranges from about 2.5 mL/g to about 3.7 mL/g. In still other embodiments, the pore volume ranges from about 2.7 mL/g to about 3.5 mL/g. In further embodiments, the pore volume ranges from about 2.9 mL/g to about 3.2 mL/g. In other embodiments, the pore volume is about 3.1 mL/g.

Diatomaceous earth products disclosed herein may have a measurable median pore diameter. Median pore diameter may be measured by any appropriate measurement technique now known to the skilled artisan or hereafter discovered. In some embodiments, median pore diameter is measured with an AutoPore IV 9500 series mercury porosimeter, as described above. In some embodiments, the median pore diameter ranges from about 3.5 μm to about 5.0 μpm. In some embodiments, the median pore diameter ranges from about 3.7 μm to about 4.4 μm. In some embodiments, the median pore diameter ranges from about 4.5 μm to about 7.5 μm. In other embodiments, the median pore diameter ranges from about 4.5 μm to about 6 μm. In further embodiments, the median pore diameter ranges from about 5.5 μm to about 7 μm.

Diatomaceous earth products disclosed herein may have a measurable wet density, which as used herein refers to measurement of centrifuged wet density. To measure wet density, a diatomaceous earth sample of known weight from about 1.00 to about 2.00 g is placed in a calibrated 15 ml centrifuge tube to which deionized water is added to make up a volume of approximately 10 ml. The mixture is shaken thoroughly until all of the sample is wetted and no powder remains. Additional deionized water is added around the top of the centrifuge tube to rinse down any mixture adhering to the side of the tube from shaking. The tube is centrifuged for 5 minutes at 2500 rpm on an IEC Centra® MP-4R centrifuge, equipped with a Model 221 swinging bucket rotor (International Equipment Company; Needham Heights, Mass., USA). Following centrifugation, the tube is carefully removed without disturbing the solids, and the level (i.e., volume) of the settled matter is measured in cm³. The centrifuged wet density of powder is readily calculated by dividing the sample weight by the measured volume. In some embodiments, the wet density of the diatomaceous earth product ranges from about 10 lb/ft³ to about 25 lb/ft³. In some embodiments, the wet density ranges from about 15 lb/ft³ to about 20 lb/ft³. In some embodiments, the wet density ranges from about 16 lb/ft³ to about 19 lb/ft³.

Diatomaceous earth products disclosed herein may include at least one soluble metal. As used herein, the term “soluble metal” refers to any metal that may be dissolved in at least one liquid. Soluble metals are known to those of skill in the art and include, but are not limited to, iron, aluminum, calcium, vanadium, chromium, copper, zinc, nickel, cadmium, and mercury. When a filter aid comprising diatomaceous earth is used to filter at least one liquid, at least one soluble metal may dissociate from the diatomaceous earth filter aid and enter the liquid. In many applications, such an increase in metal content of the liquid is undesirable and/or unacceptable. For example, when a filter aid including diatomaceous earth is used to filter beer, a high level of iron dissolved in the beer from the filter aid may adversely affect sensory or other properties, including but not limited to taste and shelf-life.

Any appropriate protocol or test for measuring levels of at least one soluble metal in diatomaceous earth products may be used, including those now known to the skilled artisan or hereafter discovered. For example, the brewing industry has developed at least one protocol to measure the BSI, or beer soluble iron, of diatomaceous earth filter aids. BSI refers to the iron content, which may be measured in parts per million, of a filter aid including diatomaceous earth that dissociates in the presence of a liquid, such as beer. In the United States, the American Society of Brewing Chemists (ASBC) has set forth a method to measure the BSI content in parts per million, wherein a sample of BUDWEISER beer is contacted with the filter aid and the resulting iron content in the beer is measured.

In the ASBC method, for example, BSI content is measured by placing a 5 g sample of diatomite in 200 mL of decarbonated beer (for example, BUDWEISER, registered trademark of Anheuser-Busch) at room temperature, and the mixture is swirled intermittently for an elapsed time of 5 minutes and 50 seconds. The mixture is then immediately transferred to a funnel containing 25 cm diameter filter paper, from which the filtrate collected during the first 30 seconds is discarded. Filtrate is collected for the next 150 seconds, and a 25 mL portion is treated with approximately 25 mg of ascorbic acid (i.e., C₆H₈O₆) to reduce dissolved iron ions to the ferrous (i.e., Fe²⁺) state (thus yielding a “sample extract”). The color is developed by addition of 1 mL of 0.3% (w/v) 1,10-phenanthroline, and after 30 minutes, the absorbance of the resulting sample solution is compared to a standard calibration curve. The calibration curve is prepared from standard iron solutions of known concentration in beer. Untreated filtrate is used as a method blank to correct for turbidity and color. Absorbance is measured at 505 nm using a spectrophotometer.

In some embodiments, the BSI of a diatomaceous earth product disclosed herein ranges from about 10 ppm to about 50 ppm, when measured using an ASBC method. In other embodiments, the BSI ranges from about 10 ppm to about 40 ppm. In further embodiments, the BSI ranges from about 10 ppm to about 30 ppm. In still other embodiments, the BSI is less than about 30 ppm.

Diatomaceous earth products disclosed herein may have a measurable BET surface area. BET surface area, as used herein, refers to the technique for calculating specific surface area of physical absorption molecules according to Brunauer, Emmett, and Teller (BET) theory. BET surface area may be measured by any appropriate measurement technique now known to the skilled artisan or hereafter discovered. In some embodiments, BET surface area is measured with a Gemini III 2375 Surface Area Analyzer, using pure nitrogen as the sorbent gas, from Micromeritics Instrument Corporation (Norcross, Ga., USA). In some embodiments, the BET surface area is greater than at least one calcined and/or flux calcined diatomaceous earth product with similar permeability, but not produced according to the exemplary processes described herein (e.g., without agglomerating at least one natural diatomaceous earth material with at least one silicone material). In other embodiments, BET surface area ranges from about 15 m²/g to about 50 m²/g. In further embodiments, the BET surface area ranges from about 20 m²/g to about 45 m²/g. In still other embodiments, the BET surface area is greater than about 20 m²/g.

### Exemplary Uses for Diatomaceous Earth Products

Diatomaceous earth products disclosed herein may be used in any of a variety of processes, applications, and materials. In some embodiments, the diatomaceous earth products are used in at least one process, application, or material in which such a product with a high BET surface area is desirable.

In some embodiments, the diatomaceous earth product may be included in a filter aid material or composition. A filter aid composition including at least one diatomaceous earth product may optionally include at least one additional filter aid medium. Examples of suitable additional filter aid media include, but are not limited to, natural or synthetic silicate or aluminosilicate materials, unimproved diatomaceous earth, saltwater diatomaceous earth, expanded perlite, pumicite, natural glass, cellulose, activated charcoal, feldspars, nepheline syenite, sepiolite, zeolite, and clay.

The at least one additional filter medium may be present in any appropriate amount. In some embodiments, the at least one additional filter medium is present from about 0.01 to about 100 parts of at least one additional filter medium per part of treated diatomaceous earth material. in other embodiments, the at least one additional filter medium is present from about 0.1 to about 10 parts. In further embodiments, the at least one additional filter medium is present from about 0.5 to 5 parts.

The filter aid composition may be formed into sheets, pads, cartridges, or other monolithic or aggregate media capable of being used as supports or substrates in a filter process. Considerations in the manufacture of filter aid compositions may include a variety of parameters, including but not limited to total soluble metal content of the composition, median soluble metal content of the composition, particle size distribution, pore size, cost, and availability.

A filter aid composition including at least one thermally-treated diatomaceous earth product may be used in a variety of processes and compositions. In some embodiments, the filter aid composition is applied to a filter septum to protect it and/or to improve clarity of the liquid to be filtered in a filtration process. In other embodiments, the filter aid composition is added directly to a beverage to be filtered to increase flow rate and/or extend the filtration cycle. In further embodiments, the filter aid composition is used as pre-coating, in body feeding, or a combination of both pre-coating and body feeding, in a filtration process.

Thermally-treated diatomaceous earth filter aid products of the present disclosure may also be used in a variety of filtering methods. In some embodiments, the filtering method includes pre-coating at least one filter element with at least one thermally-treated diatomaceous earth filter aid, and contacting at least one liquid to be filtered with the at least one coated filter element. In such embodiments, the contacting may include passing the liquid through the filter element. In other embodiments, the filtering method includes suspending at least one thermally-treated diatomaceous earth filter aid in at least one liquid containing particles to be removed from the liquid, and thereafter separating the filter aid from the filtered liquid.

Filter aids including at least one diatomaceous earth product may also be employed to filter various types of liquids. In some embodiments, the liquid is a beverage. Exemplary beverages include, but are not limited to, vegetable-based juices, fruit juices, distilled spirits, and malt-based liquids. Exemplary malt-based liquids include, but are not limited to, beer and wine. In other embodiments, the liquid is one that tends to form haze upon chilling. In further embodiments, the liquid is a beverage that tends to form haze upon chilling. In further embodiments, the liquid is an oil. In still other embodiments, the liquid is an edible oil. In further embodiments, the liquid is a fuel oil. In some embodiments, the liquid is water, including but not limited to, waste water. In further embodiments, the liquid is blood. In still other embodiments, the liquid is a sake. In further embodiments, the liquid is a sweetener, such as, for example, corn syrup or molasses.

Diatomaceous earth products disclosed herein may also be used in applications other than filtration. In some embodiments, the diatomaceous earth products are used as composites in filler applications, such as, for example, fillers in construction or building materials. In other embodiments, the diatomaceous earth products are used to alter the appearance and/or properties of paints, enamels, lacquers, or related coatings and finishes. In further embodiments, the diatomaceous earth products are used in paper formulations and/or paper processing applications. In still other embodiments, the diatomaceous earth products are used to provide anti-block and/or reinforcing properties to polymers. In further embodiments, the diatomaceous earth products are used as, or in, abrasives. In still other embodiments, the diatomaceous earth products are used for buffing, or in buffing compositions. In further embodiments, the diatomaceous earth products are used for polishing, or in polishing compositions. In other embodiments, the diatomaceous earth products are used in the processing and/or preparation of catalysts. In further embodiments, the diatomaceous earth products are used as chromatographic supports or other support media. In still other embodiments, the diatomaceous earth products are blended, mixed, or otherwise combined with other ingredients to make monolithic or aggregate media useful in a variety of applications, including, but not limited to, supports (e.g., for microbe immobilization) and substrates (e.g., for enzyme immobilization).

Unless otherwise indicated, all numbers expressing quantities of ingredients, reaction conditions, and so forth used in the specification, including the claims, are to be understood as being modified in all instances by the term “about.” Accordingly, unless otherwise indicated to the contrary, the numerical parameters are approximations and may vary depending upon the desired properties sought to be obtained. At the very least, and not as an attempt to limit the application of the doctrine of equivalents to the scope of the claims, each numerical parameter should be construed in light of the number of significant digits and ordinary rounding approaches.

Combinations of the various exemplary embodiments are contemplated. Other embodiments of the invention will be apparent to those skilled in the art from consideration of the specification and practice of the exemplary embodiments disclosed herein. It is intended that the embodiments and examples disclosed in the specification be considered as exemplary only, with a true scope and spirit of the invention being indicated by the claims.

### EXAMPLES

The results obtained by testing the following Examples 1-16 are illustrated in Table 1. The effects of varying the amount and type of silicone material and the amount of water included in the agglomeration on physical properties of the diatomaceous earth product are shown in Table 1.

The particle size distributions of Examples 1-16 were measured using a Leeds and Northrup Microtrac X100 laser particle size analyzer. The wet density and permeability were measured by the exemplary methods described above.

### Examples 1-4

A commercially available Celite® S diatomite product (originating from Mexico) was used as the feed diatomaceous earth (DE) material. This DE feed material had a particle size distribution of d₁₀ of 7.35 μm, d₅₀ of 21.09 μm, and d₉₀ of 58.45 μm.

For examples 1-4, 6 to 30 g of silicone powder (Silres MK, Wacker) was dispersed in 20 g of water. The silicone solution was then slowly added to 200 g of the DE feed material with agitation. After mixing in a Hobart mixer for 20 minutes, the mixture was brushed through a 16-mesh (1.19 mm opening) screen. The oversize particles were broken and forced through the screen by brushing. Thereafter, 30 g of the agglomerated DE material was calcined at 1,000° C. for 30 minutes in an Inconel crucible. The calcined DE material was then screened through a 30-mesh (0.6 mm opening) screen by brushing. Permeability, wet density, and particle size distribution (d₁₀, d₅₀, and d₉₀) of the finished products are listed in Table 1.

### Examples 5-14

A diatomite crude originating from Mexico (Massive crude) was used as the feed DE material. This feed DE material had a particle size distribution of d₁₀ of 6.90 μm, d₅₀ of 19.65 μm, and d₉₀ of 58.72 μm.

For Examples 5-14, 2 or 4 g of liquid silicone (Silres BS series, Wacker) was dispersed in 20 or 40 g of water. The silicone solution was then slowly added to 200 g of the DE feed material with agitation. After mixing in a Hobart mixer for 20 minutes, the mixture was brushed through a 16-mesh (1.19 mm opening) screen. The oversize particles were broken and forced through the screen by brushing. Thereafter, 30 g of the agglomerated DE material was calcined at 1,000° C. for 30 minutes in an Inconel crucible. The calcined DE material was then screened through a 30-mesh (0.6 mm opening) screen by brushing. Permeability, wet density, and particle size distribution (d₁₀, d₅₀, and d₉₀) of the finished products are listed in Table 1.

### Examples 15 and 16

For Examples 15 and 16, Example 5 was repeated, except 6 g or 10 g of food grade white silicone (Clearco) was dispersed in 20 g of water instead of the liquid silicone (Silres BS series, Wacker) of Example 5. Permeability, wet density, and particle size distribution (d₁₀, d_{50,} and d₉₀) of the finished products are listed in Table 1. Other physical properties of Example 16 are listed in Table 2. The total crystalline silica of cristobalite and quartz is less than 1% in Example 16. In comparion, the regular calcined diatomite product Celite 577 has a total crystalline silica of 17%. The low crystalline in Example 16 is due to the low calcination temperature. There is no difference in pH value between the regular calcined diatomite product Celite 577 and Example 16. Beer soluble iron (BSI) of the Example 16 is about 29 ppm, and conductivity is about 33 μm.

TABLE 1

| | | Binder | Water | Permeability | Wet Density | | | |
|---|---|---|---|---|---|---|---|---|
| Examples | Silicone Binder | (%) | (%) | (Darcy) | (lb/cf) | d₁₀ | d₅₀ | d₉₀ |
| Celite ® Standard | | | | 0.27 | 18.9 | 8.97 | 22.91 | 65.91 |
| Super Cell ® | | | | | | | | |
| Celite ® 577 | | | | 0.21 | 20.1 | 8.82 | 23.87 | 62.48 |
| 1 | Wacker Silres MK | 3 | 10 | 0.26 | 16.4 | 9.92 | 30.10 | 79.48 |
| 2 | Wacker Silres MK | 5 | 10 | 0.35 | 16.2 | 12.12 | 30.41 | 80.93 |
| 3 | Wacker Silres MK | 10 | 10 | 0.42 | 16.0 | 10.29 | 31.29 | 82.58 |
| 4 | Wacker Silres MK | 15 | 10 | 0.45 | 16.9 | 10.68 | 33.46 | 85.77 |
| 5 | Wacker Silres BS 1001 A | 1 | 10 | 0.36 | 12.7 | 9.02 | 29.19 | 74.92 |
| 6 | Wacker Silres BS-97 | 1 | 10 | 0.27 | 13.6 | 8.92 | 26.26 | 74.06 |
| 7 | Wacker Silres BS-45 | 1 | 10 | 0.25 | 13.9 | 9.08 | 27.54 | 79.95 |
| 8 | Wacker Silres BS-16 | 2 | 10 | 0.30 | 13.7 | 8.48 | 26.05 | 78.17 |
| 9 | Wacker Silres BS-1042 | 2 | 10 | 0.26 | 13.5 | 8.214 | 24.84 | 73.24 |
| 10 | Wacker Silres BS-94 | 1 | 10 | 0.16 | 14.2 | 8.312 | 26.01 | 75.73 |
| 11 | Wacker Silres BS-46 | 1 | 10 | 0.20 | 14.5 | 8.57 | 25.80 | 73.60 |
| 12 | Wacker Silres BS-46 | 2 | 10 | 0.21 | 14.3 | 8.56 | 27.00 | 81.87 |
| 13 | Wacker Silres BS-17040 | 1 | 10 | 0.18 | 14.5 | 8.63 | 26.39 | 76.78 |
| 14 | Wacker Silres BS-17040 | 1 | 20 | 0.29 | 14.4 | 9.05 | 25.55 | 76.26 |
| 15 | Clearco white silicone | 5 | 10 | 0.23 | 14.7 | 8.69 | 23.63 | 59.43 |
| 16 | Clearco white silicone | 3 | 10 | 0.22 | 15.0 | 8.67 | 23.50 | 59.52 |

TABLE 2

| | Cristobalite | Quartz | BSI | | Conductivity |
|---|---|---|---|---|---|
| Sample ID | (%) | (%) | (ppm) | pH | (uS) |
| Celite 577 | 16.52 | 0.15 | 16.9 | 6.5 | 9.8 |
| Example 16 | 0.71 | 0.21 | 29.2 | 6.0 | 33.2 |

### Example 17

For Example 17, a sample of the diatomaceous earth product of Example 3 was tested for filtration performance as a filter aid composition using a pressure filtration process. The diatomaceous earth sample was applied to a septum (often referred to as “pre-coating”) and added directly to the fluid (often referred to as “body-feeding”). A Walton filter from Celite Corporation was used for the pressure filtration. For this example, 2 g of the sample was used as the pre-coat, and 4 g of the sample was added as body-feed, to 2 liters of solution containing 10 g of OVALTINE® fine chocolate. The flow rate was controlled at 30 ml/min. The same test was run with Celite® Standard Super Cel® as the filter aid composition as a comparison.

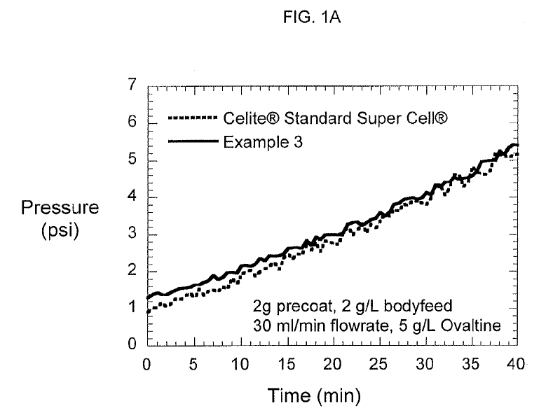

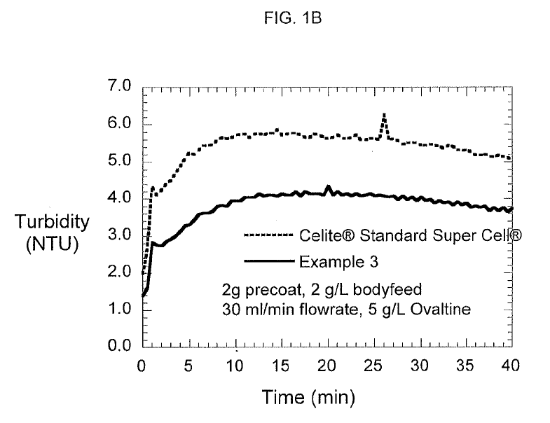

As illustrated in FIGS. 1A and 1B, the pressure increase for the sample from Example 3 was similar to Celite® Standard Super Cel®, but the turbidity was about 25% lower for the sample from Example 3. The decreased turbidity using the inventive sample indicates that the inventive sample of Example 3 displays improved filtration over the commercially available Celite® Standard Super Cel® filter aid.

### Example 18

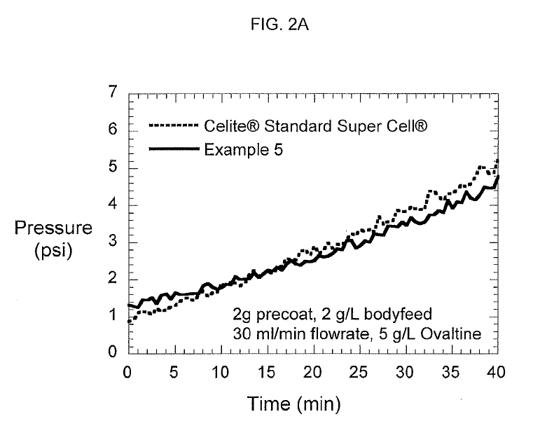

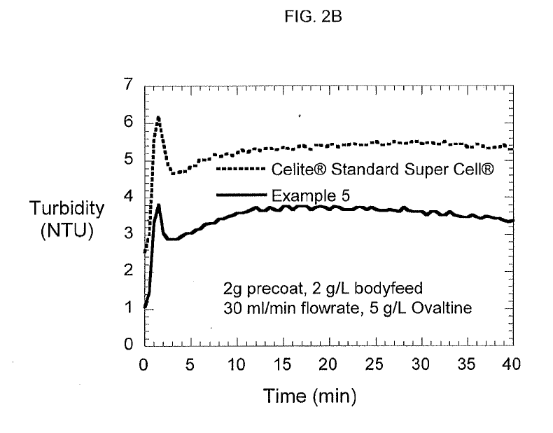

For Example 18, the filtration performance test described in Example 17 was repeated for a sample of the diatomaceous earth product of Example 5, with Celite® Standard Super Cel® as a comparison. As illustrated in FIGS. 2A and 2B, the pressure increase for the sample from Example 5 was similar to Celite® Standard Super Cel®, but the turbidity was about 30% lower for the sample from Example 5.

Example 19

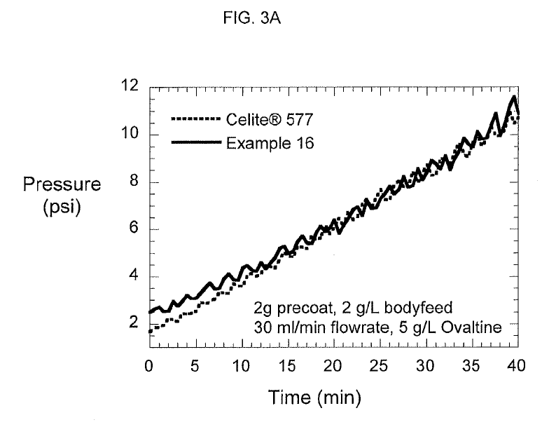

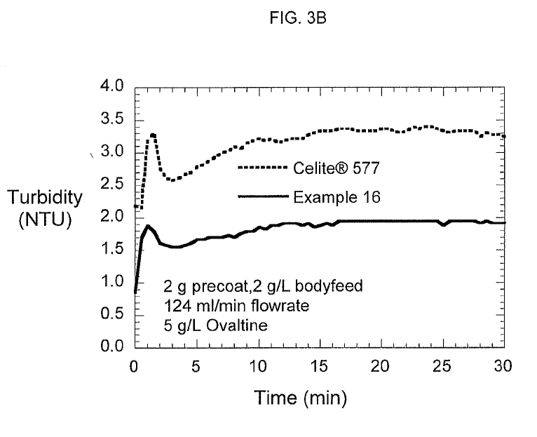

For Example 19, the filtration performance test described in Example 17 was repeated for a sample of the diatomaceous earth product of Example 16, with Celite® 577 as a comparison. As illustrated in FIGS. 3A and 3B, the pressure increase for the sample from Example 16 was similar to Celite® 577, but the turbidity was about 45% lower for the sample from Example 16.

1-47. (canceled)

48. A process for preparing a diatomaceous earth product, the process comprising:
agglomerating at least one natural diatomaceous earth with at least one silicone material, and
subjecting the agglomerated diatomaceous earth to at least one heat treatment at a temperature ranging from about 600° C. to about 1,000° C.,
wherein the agglomerating comprises preparing at least one aqueous solution comprising the at least one silicone material, and contacting the at least one natural diatomaceous earth with the at least one aqueous solution.

49. The process of claim 48, further comprising subjecting the at least one natural diatomaceous earth to at least one classification step prior to agglomerating.

50. The process of claim 48, wherein the at least one aqueous solution comprises less than about 20% by weight water, relative to the weight of the diatomaceous earth.

51. The process of claim 50, wherein the aqueous solution comprises less than or equal to about 10% by weight water, relative to the weight of the diatomaceous earth.

52. (canceled)

53. The process of claim 48, wherein the aqueous solution comprises about 1% to about 10% by weight of the at least one silicone material, relative to the weight of the diatomaceous earth.

54. The process of claim 53, wherein the aqueous solution comprises about 1% to about 5% by weight of the at least one silicone material, relative to the weight of the diatomaceous earth.

55. The process of claim 48, wherein the contacting comprises spraying the at least one aqueous solution onto the at least one natural diatomaceous earth.

56. The process of claim 48, wherein the at least one silicone material comprises a silicone polymer comprising at least one of linear polymers, ring-shaped polymers, branched polymers, cross-linked polymers, and resins.

57. The process of claim 48, wherein about 0.25 parts to about 1.5 parts of the at least one aqueous solution is contacted with about 1 part of the at least one natural diatomaceous earth.

58. The process of claim 57, wherein about 1 part of the at least one aqueous solution is contacted with about 1 part of the at least one natural diatomaceous earth.

59. The process of claim 48, wherein the diatomaceous earth product has a d₁₀ ranging from about 8.0 μm to about 15.0 μm.

60. The process of claim 48, wherein the diatomaceous earth product has a d₅₀ ranging from about 20 μm to about 40 μm.

61. The process of claim 48, wherein the diatomaceous earth product has a d₉₀ ranging from about 55 μm to about 120 μm.

62. The process of claim 48, wherein the diatomaceous earth product has a permeability ranging from about 0.2 darcy to about 2.5 darcies.

63. The process of claim 48, wherein the diatomaceous earth product has a quartz content less than about 1% by weight.

64. The process of claim 48, wherein the diatomaceous earth product has a cristobalite content less than about 1% by weight.

65. The process of claim 48, wherein the diatomaceous earth product has a pore volume ranging from about 3.5 mL/g to about 5.0 ml/g.

66. The process of claim 48, wherein the diatomaceous earth product has a median pore diameter ranging from about 3.5 μm to about 5.0 μm.

67. The process of claim 48, wherein the diatomaceous earth product has a wet density ranging from about 10 lb/ft³ to about 25 lb/ft³.

68. The process of claim 48, wherein the diatomaceous earth has a beer soluble iron content of less than about 40 ppm, as measured by ASBC.
